(19) United States
(12) Patent Application Publication
(10) Pub. No.: US 2024/0095839 A1
(43) Pub. Date: Mar. 21, 2024

(54) Property Conditions Assessment and Analysis Through a Spatial Analysis Model

(71) Applicant: Jarrod Burns, Rosenberg, TX (US)

(72) Inventor: Jarrod Burns, Rosenberg, TX (US)

(21) Appl. No.: 18/257,870

(22) PCT Filed: Dec. 15, 2021
(86) PCT No.: PCT/US21/10064

§ 371 Date: Jun. 15, 2023

(51) Int. Cl. G06Q 40/08

(52) U.S. Cl. CPC G06Q 40/08

(57) ABSTRACT

A system incorporating tools for examining structures, property and related area conditions, through (1) externally and internally captured images, (2) external and internal manual inspection(s), (3) instrument measurement, (4) publicly and/or privately available property descriptions, and (5) publicly and/or privately available data images, in conjunction with (6) meteorological and time data, to provide a forensic analysis of conditions causation and derivation of property loss. The system is utilized to accurately collect, preserve, document, analyze, and present data associated with properties, buildings, or valuable assets in an accessible and centralized database that allows for principals to utilize a graphically interactive model to both input data, on the one hand, and dynamically select and retrieve desired information based on visual electronic cues, on the other hand, that graphically depict physical conditions, or changes to conditions, on property, structures, or valuable assets.

### FIELD OF THE INVENTION

The present invention involves a system and method for collecting, documenting, examining, analyzing, and presenting structural and related property condition(s), via multifaceted means, through (1) externally and internally captured images, (2) external and internal manual inspection(s), (3) analytical instrument measurements, (4) publicly and/or privately available property descriptions, and (5) publicly and/or privately available visual data images, in conjunction with (6) meteorological and time data, generally. It is the goal of the present invention to provide a forensic analysis of presence of condition(s), potential and actual changes in conformational condition(s) causation, extent of conditions' change, derivation of destruction and reparability. Specifically, data may be derived from gathered visual recordation (captured from imaging recording devices), analytical data (e.g., severity, location, occurrence rates, and extent of conditions and changes in conditions, instrumentation measurements (e.g., length and visibility of glazing blemish(es), extent of frame movement), physical inspections (on-site observance, recordation and data collection), analysis of inspection reports and historical repositories of previously collected condition(s) data and related area(s) data of property loss incidents, extents, and types. Data points are then compared and compiled into an opinion(s), assessing the existence of property condition(s), extent of condition(s), condition(s) derivation, and (potential and actual) primary and secondary causes. The repository encompasses, for each property condition event type, a catalog of event-related, manufacture-related, wear-related, and age-related factors attributable to all manner of property loss events with which to compare newly collected and derived condition information to develop and provide an accurate assessment of potential, probable and actual property conditions or change in condition's cause or causes.

### BACKGROUND

Typically, when a loss event occurs to a property, including structures as well as contiguous areas, it is common for the property owner to seek to remedy said loss condition(s) and return a property to its pre-loss state (or as much as is practicable). And, while the property owner may bear the cost of repair, more commonly the owner will contract with, employ, and rely on a third party (i.e., an insurer) to carry and reimburse the majority of costs (minus any required deductible) through the property owner's insurance policy. This policy sets out the insured, coverage areas, parameters, and circumstances, as well as defined avenues, and term for claiming said coverage. Once an insured experiences loss to property, the property owner (“insured”) files a claim with the insurer. The insurer assesses the loss, investigates the claim (and identified loss condition(s)), and determines the cause of the condition(s). If the loss is a result of a covered event and the identified loss condition(s) occurs within a specified term of the insured's policy, the insurance either denies the claim, reimburses the insured or coordinates repairs up to an agree upon coverage limit. In this way the property will be restored to its pre-loss state and the property owner will be made whole, or as nearly whole as is monetarily compensable.

Historically, property owners and insurers alike, have relied almost exclusively upon inspection reports, constructed by claims inspectors and claims adjusters, to construct a plausible history of loss events, connecting loss condition(s) with origin, and discovering the most probable causative nature of structure and property loss. These inspector's and adjustor's duties are to reconcile loss condition(s) with a causative source, validate the insured's claim, determine the scope of the claim, determine the extent of loss condition(s), and to arrive at a monetary or remedial recompense.

Yet, inspections are highly subjective, inspector dependent, and prone to human error. Adding to the inconsistency between and among reports and reporters, there is a wide variation in industry standards for inspection, certifications, inspection education, inspector training, as well as varying standards among and between industry regulations and policies.

Adjustors themselves have a wide-ranging skill set, which is directly dependent upon the years of training and experience of each adjustor wherein a single weather event can produce intensive strain on a group of qualified and available adjustors in a loss dense area or zone. It is not uncommon for significant weather events to require hundreds, if not thousands, of qualified adjusters to perform multiple daily on-site inspections in a relatively short time period subsequent to a weather event in order to settle claims promptly and accurately. Unfortunately, the physicality and physical presence of an adjuster presents practical constraints on inspections and imposes limits on an adjuster's ability to operate in a time-efficient and effective manner. These limitations result in claim settlement decisions that may span weeks to months which leaves property owners with loss condition(s) unremedied, final settlements delayed, and protracted time and cost to the insured as well as the insurer.

Although, discrepancies between and among reports have been sought out for reconciliation by a great number of technological advancements in the filed which utilize GPS, aerial photography, extrapolated data, computer-generated models, and simulations and “automated” insurance claims adjustment with which to attempt to provide a more efficient and economical means of identifying, defining, and assessing loss condition(s). Yet none to date has been able to improve upon the physical presence of an inspector/adjustor and the implementation of a true visual inspection comprising the “gold standard” and cornerstone of effective claims adjustment after an identified loss.

The present invention, the SAM (Spatial Analysis Model), does not rely exclusively upon a single adjustor, or extrapolations based on a representative sample, but rather it relies upon several sources of objective data whose compilation is utilized to construct a complete and thorough analytical overview of property condition(s). Said data may be viewed on the whole or selected individually as to make determinations on a large scale or down to individual units or areas (e.g., units, subunits or areas of a building). Moreover, this same macro and micro data is subjectable to rigorous analysis, examination and built-in redundancies thereby providing an objective review of the causative nature of structural and property condition(s). This data is then compared in toto with a bank of historical data by which to make analytical comparisons, determine causation of changes in conditions, and eventually to become an instructive addition to a historical repository.

Unlike other attempts at conditions assessment, the SAM (spatial analysis model) process does not purport to form or direct an opinion based solely on observation, technology, and/or artificial intelligence in isolation but instead relies on data input from weather and time data, a technician, one or more technicians or a plurality of technician(s) data entry, analytical measurements and historical information (past and present weather conditions and patterns, timelines and inspection materials) thus providing a more efficient, more reproducible (dependable) and more streamlined means of collecting, preserving, analyzing, and presenting collected, recorded and stored data. Yet rather than offering a final conclusory statement or causative decision, the consumers of the data are able to form opinions, whether inclusive or exclusive, independent of, but in conjunction with and reliance upon, the SAM (spatial analysis model) system in confidence and support based upon data provided by SAM. In opposite of other patents utilizing modern visual technology gathering techniques (i.e., drone data capture, photographic evidence), which assert features that allow the systems to form opinions independent of human thought, the SAM system relies on human inspection, human judgment, and input in concurrence with detailed analytical fact gathering, data collection and uniform consolidation, recordation, processing and presentation.

### SUMMARY OF THE INVENTION

The present invention provides a comprehensive system and method for inspecting, examining, recording, documenting, annotating, collecting, analyzing, and presenting data in the comprehensive assessment of property condition(s) (e.g., structural condition(s), fenestration condition(s), glass scratching, fogging, and fracture, HVAC equipment conditions, roof condition(s) etc.), analyzing areas and extent of change of property condition(s) and differentiating said condition changes on the basis of weather events (i.e., wind, rain, hail, lightening) verses condition changes due to wear, manufacturing defect, age, or other detrimental (man-made) actions. The informational assessment is then compiled into a comprehensive visual and written conditions report, providing a unique micro and micro interactive capability, for private property owners, insured, insurers, reinsurers, and various other involved or interested parties and consumers (ex. adjusters, attorneys).

Concisely, the present invention allows for the differentiation between changes in (a) condition(s)“caused by nature”: meteorological and/or seismic events (e.g., wind, rain, lightening (primarily) or earthquake) and/or (b) condition(s) “caused by man”: fire (secondarily), explosive, vandalism, or other nefarious activity, as opposed to (c) those condition changes caused by age, wear, or manufacturing (latent) defects. Moreover, the present system allows for further distinctions to be made wherein a combination of these types of condition(s), or change in conditions, may be linked as occurring sequentially, temporaneously, or contemporaneously with one another as defined by their conglomeration or clustering, for example, fenestration fracturing, scratching, fogging, or a combination thereof, occurring on a windward side of a structure (as opposed to a non-windward side receiving indirect forces). This distinction may be based on observed conditions, available imagery, measured conditions (i.e., imaging), changes in conditions, conditions clustering, conditions orientation, spatial relation between and among conditions locations, sourced building codes and regulations (ex., ratings and tolerances) and accepted industry materials standards (e.g., AAMA standards, ASTM standards) or a combination thereof.

The system and method itself consist of a spatial analysis model (SAM) and defined inspection process which utilizes integrated manual (and, when warranted, automated) diagnostic technologies designed and implemented to accurately inspect, collect, record, preserve, analyze, and present conditions data associated with properties, buildings, or valuable assets. The SAM process provides a centralized data collection depot for all involved and interested parties' access by those parties involved in data collection and analysis of a property, structure, or other valuable asset(s), on the one hand, and consumers of that data, on the other hand. The process is an innovation of the means of data collection, preservation, analysis, and presentation that have long been desired in the industry to communicate existing conditions and causation opinions, as described herewith, in an accurate, expedient and labor-efficient manner. The SAM process utilizes novel technological advancements to provide a more accurate, reliable, and visually interactive platform for utilizers of relevant collected data.

In addition, the present invention provides interactive access to data through visual models allowing for a scalable and selectable viewing via a Graphic User Interface (GUI) which allows the information consumer to ingest conditions (and changes in conditions) on granular levels as well as high levels (and all point in between). By providing this information in a graphically interactive model, consumers of the data may dynamically retrieve desired information based on electronic cues that visually depict physical conditions on the property, structure, or valuable assets both photographically, representationally and in a written form. As a result, consumers of the data may more quickly and accurately retrieve relevant information, interpret data, and/or make decisions based on appropriate data in real time rather than the traditional methods of sampling and extrapolation, resulting historically in cumbersome retrieval and costly delays in acquiring, viewing and interpreting conditions data.

At its core, the SAM system itself captures images and data, both external and internal, in an existing structure to facilitate the conditions inspection process. Through on-site inspections, one to a plurality of inspectors capture and log videographic evidence and photographic imagery which is then annotated with specific descriptions verbally and in written form. Said on-site, visual inspection and evaluation of building elements (e.g., fenestrations conditions (fogging, scratching and fracturing), window and door frame conditions (bent, dislodged, dislocated or otherwise compromised), HVAC equipment condition, roof condition(s), external marker conditions, or a combination thereof, are collected both externally (via photographic imaging, drone imaging) and, when accessible internally, where accessibility and permission is granted by a unit's owner within a larger structure (e.g., condominium). Or, where the structure is a single owner, permission is procured from a single source.

Each technician or technicians (or team or teams of technicians) then conduct inspections, combining several points of observed conditions assessment (i.e., structural conditions, exterior conditions, interior conditions and the like) and potential causation (e.g. severe and significant weather events versus historical conditions or conditions due to wear, age or disrepair) into a descriptive series of events most closely approximating actual significant weather events through the accumulation and grouping of material data, inclusive and exclusive, as an identifiable element in a comprehensive data set.

These data points are taken together, with relevant metrological data, and objective event timelines, into one to a number of analytical report(s), those reports comprising (a) architectural and structural conditions (retrospective) and salvageability (prospective) reports, due to (b) a distinguishable and definable significant weather event (a wind event, rain event, hail event, fire event and the like) that is identifiable and measurable. Such conditions may include, but is not limited to, glass fracturing, scratching and/or fogging, related fenestration conditions and/or conditions to or around windows and door frames, water infiltration, wind pressures and forces attributable directly to specific weather event or subsequent or collaterally related conditions changes. Additionally, information may be gathered in the negative wherein accumulated conditions data may indicate data points that are not, or may not be, directly attributable to a specific event, taking into consideration pertinent meteorological data and plausible causation scenarios. Too, heat-related conditions, smoke-related conditions, and water leakage and infiltration may be analyzed as would naturally occur during the course of a natural or man-mad fire event occurring within the context of a specific weather event or exclusive of that particular event. What is more, certain conditions and conditions changes may be attributable to a prior event wherein these conditions may be readily identifiable to a significant weather event, but not the specific weather event in question.

As well, construction defects (including air and water leakage) at building enclosure system openings (i.e., fenestrations), may be collected, recorded and analyzed including doors, windows, skylights, storefront assemblies, curtain walls, claddings, roofing and flashings due to significant building performance issues (e.g., moisture-related deterioration, microbial growth resulting in reduced life-expectancy, increased maintenance, and increased energy consumption) which may be weather event related, age, wear or installation related, construction related or wholly or partially unrelated.

Too, the present system parameters allows for incorporating and conglomeration of several reports by which accumulated data may be utilized to assemble a more complete picture of conditions including: wind/hail/water storm conditions assessment reports, fire origin and causal conditions assessment reports, fire, smoke and extinguishing water (interior and exterior) conditions, explosion origin and causal conditions assessment reports, foundation assessments, structural reports, HVAC assessment reports, meteorological data reports, timeline reports, property descriptions—private, public and area properties, publicly available images as well as other causal, temporal and relevant data.

The goals of the present invention may be accomplished by comparing (a) inspected elements, assemblies and properties for conditions, or changes thereof, attributable to rain, wind and wind-related events, wind-rain or wind-rain-hail combined events (e.g., fractured glazing, fogged glazing, scratched glazing, displaced and disconnected elements and/or dented/abraded fenestration frames resulting in water and moisture infiltration, hail damage, storm surge flooding, fire (natural and man-made), earthquake, versus (b) conditions not attributable to wind, rain, seismic and water effects (e.g., those conditions of defects in manufacture, improper installation, aging and/or mechanical defects). Moreover, the present invention has the ability to differentiate seismic, rain, flooding, wind and wind-related events causing conditions or changes in conditions from non-seismic, non-rain, non-flood and non-wind related events causing conditions and those condition changes potentially instigated by a third party or a property owner or other parties, themselves, and to quickly and efficiently compare and analyze the gathered information and present data in a more accurate, usable, and accessible format.

Yet another goal of the present invention may be accomplished by analyzing, spatially, the relative relation and occurrence of non-weather event related conditions (e.g., wear, age, improper installation) compared to those that are observed after a weather event (e.g., seismic, fire, wind, hail and water) versus non-natural sources (non-seismic, non-fire, non-wind, non-water effects, non-aging and non-wear) to determine the ‘root cause’ of immediate conditions in structures and property as opposed to advanced age, prolonged wear or exposure to the elements conditions, by studying the nature, frequency and location of various observed and measured conditions and conditions changes; comparison of various related conditions (i.e., observed and recorded conditions) documented in the immediate vicinity and surrounding areas of the subject property (e.g., seismic activity, wildfires, storm surge, wind velocity, wind direction and geographically related storm data); observing and analyzing other spatially and geographically related structures and conditions; comparing various recently observed and measured occurrences against historically observed and measured events; and observing occurrences determined to be the result of weather event related conditions causation (example: comparing a fogged glazing occurring on wind-ward facing fenestrations vs. fogged glazing occurring on non-wind-ward facing fenestrations, along with distribution thereof, across an outward facing façade to determine origin and cause of property loss).

It is another goal of the present invention to use observed, measured, collected and recorded data to determine the cause of property loss resulting from wind, wind-water, water (rain, storm surge and flooding), lightening, electrical causes, fire, explosives and seismic occurrences as opposed to structural and mechanical wear and failures, using observed, measured and surveyed present and historical data. Additionally, this data may be used to distinguish the two aforementioned causes of property loss, (a) significant weather event-derived event and/or (b) wear/age/improper installation influenced conditions, or a combination thereof, from (c) man-made causes, (d) historical conditions or lack of any thereof. Such data may include photographic, imaged, scanned or otherwise determinable and measurable data ascertaining the architectural stability and fenestration (and related structure) conditions occurring in a building versus wear, age and improper installation and fraudulently created conditions wherein all three may occur separately or in combination thereof.

Specifically, building enclosure systems may be compromised wherein, for example, doors, windows, skylights, storefront assemblies, curtain walls, claddings, roofing and flashings allow both air, rain and moisture into a building structure. Such “leaks” may be due to manufacturing defects, improper handling, defective conditions, damage during shipping, improper construction and/or installation, as is proved herein, or a significant weather or storm event. Yet, regardless of the cause, such conformational changes to building enclosure systems, and the resultant conditions, together with remediation to the underlying cause(s), can be expensive to repair. But the cause itself is important to understand wherein the origins of the conditions changes itself goes (1) to the cause and (2) to determining the redress wherein certain causes and conditions create liabilities in disparate parties. Thereby, if property a conformational change in conditions is caused by a weather-related event and associated wind, hail and/or water conditions exacerbate that initial affront, a causal relationship may be established through collected evidence and a defined series of proposed consequent events.

Accordingly, it is paramount, before undertaking any repairs, to determine causality where certain determinations must first be made to address the following, inexhaustive, exemplary list in reference to water leakage:
Did the leakage occur as a result of a storm event?
Was the product expected to leak based on the performance ratings, often referred to as wind-driven rain (common during high wind events)?
Did the leakage occur within the manufactured product, or did it occur at the product's integration into the building enclosure?
Did the leakage occur in another system, such as a cladding or penetration?
Was the leakage observed at other sites spatially relative to the leakage in question?
Was the leakage coincidental and unrelated, such as from a nearby assembly, condensation or a plumbing element?

Clearly, there exists several unaddressed insufficiencies in the field of causative forensic conditions analysis and a need exists to speak to the various disparities and discrepancies that are replete within the industry in terms of claim, claims analysis and claims settlement as well as in disputes arising therefrom.

The present invention acknowledges and addresses the previously discussed shortcomings and long-felt needs in the art and provides solutions to those deficiencies via its various possible embodiments and equivalents thereof. To one having skill in this art who has the benefits of this invention's disclosure, teachings, and suggestions, other uses and advantages will be appreciable from the following detailed description and preferred embodiments taken in conjunction with the accompanying drawings and appended claims. Though the detail in these various descriptions is not to be taken on a limited basis by the particular embodiments disclosed but rather covers all counterparts and alternative embodiments.

### BRIEF DESCRIPTION OF THE DRAWINGS

While the novel features of the present system and method of use are set forth in the application itself, as well as a best contemplated modes of use and preferred embodiments thereof, the invention itself is best understood by referencing the following detailed description when read in light of the below described figures in view of the claims, wherein:

FIG. 1 depicts windward facing structural elements.

FIG. 2 illustrates increased received wind velocity with increasing height.

FIG. 3 shows fractured glazing.

FIG. 4 shows loose or fogged glazing.

FIG. 5 depicts dented, bent, broken, separated, or bowed door and window frames.

FIG. 6 is a dislodged sliding door frame.

FIG. 7 illustrates an input and graphic user interface (GUI) for data entering and collection.

FIG. 8 is an GUI screen for selecting data entry choices for data collection for Fenestration Types.

FIG. 9 is a dropdown menu depicting a plurality of selectable Fenestration Types.

FIG. 10 is one exemplary selection from a plurality of selectable Fenestration Types.

FIG. 11 is a dropdown menu depicting a plurality of selectable Frame Materials.

FIG. 12 is one exemplary selection from a plurality of selectable Frame Materials.

FIG. 13 is a dropdown menu depicting a plurality of selectable Scratched Glazings.

FIG. 14 is one exemplary selection from a plurality of selectable Scratched Glazings.

FIG. 15 is a fillable filed designating the number or quantity of Scratched Panels.

FIG. 16 is a fillable field for annotating or describing conditions coincident with Etched Glazing.

FIG. 17 is a method for accessing accurate conditions models through various inputs in the SAM process.

FIG. 18 depicts a representational structure denoting inspector access.

FIG. 19 represents a change in fenestrations conditions on a representational structure.

FIG. 20 illustrates a change in railings conditions on a representational structure.

FIG. 21 depicts a contiguous property and representative event-induced condition changes.

FIG. 22 illustrates a

Although the invention itself and method of use are amendable to various modifications and alternative configurations, specific embodiments detailed within have been shown by way of example in the drawings and are herein described in adequate detail to teach those having skill in the art how to make and practice the same. It should, however, be understood that the above description and preferred embodiments disclosed, are not intended to limit the invention to the particular embodiment disclosed, but on the contrary, the invention disclosure is intended to cover all modifications, alternatives and equivalents falling within the scope and spirit of the invention as defined within the claim's broadest reasonable interpretation consistent with the specification.

### DETAILED DESCRIPTION OF THE INVENTION

While advantages of the present invention will be readily apparent to those having skill in the art, based on the appended description, there are described certain embodiments, designs, and uses constituting the present invention and examples for illustrative purposes. And, although the following detailed description contains specific references to configurations and models, one attempting to practice said invention will certainly appreciate that modifications, alterations, and variations are within the scope of the present invention. Accordingly, the following embodiments of the invention are set forth without any loss of generality to, and without imposing limitations upon, the claimed invention. While preferred embodiments are described in connection with the description herein, there is no intent to limit the scope to the embodiments disclosed below. On the contrary, the intent is to cover all permutations, iterations, alternatives, modifications, and equivalents.

### Event Related Conditions

The SAM process itself is initiated when a system administrator or administrators receive a scope of work (SOW) tied to a specific claim indicating the property, structures, or combination thereof, is to be inspected. Such a SOW would typically ask an administrator or administrators to document conditions and, where existing, changes in conditions, consistent with the effects of, for example, wind, rain, wind-rain, hail events, which in this particular case, is a tropical storm and hurricane, if any. For the present exemplary understanding, though, said structure and subject property is set in the Gulf Shores, Alabama and Pensacola, Florida area. Yet, while conditions are typically received due to a wind-rain-hail event, especially on coastal areas, the present invention is amendable to various natural and man-made occurrences familiar to casualty insurance resulting in effects to structural and surrounding property conditions including seismic activity, electrical fires, as well as any related structural conditional changes.

A key first step in determining the circumstances surrounding a potential conditions, conditions, or changes in conformational conditions must be thoroughly defined. For example, in the case of a hurricane (e.g., Hurricane Sally in 2020) and wind and related activity, it is germane to obtain relevant weather and time data for the area affected and that area encompassing said structures or property. In the case of Hurricane Sally, this directly impacted area consists of certain areas of Orange Beach, Alabama and upper Florida, specifically Pensacola, Florida. Data was thereby gathered from the National Weather Service (NWS) and NOAA National Centers for Environmental Information (NCEI), although other meteorological sources may be utilized, with information derived from the nearest weather station at Pensacola International Airport.

Hurricane Sally was a slow-moving disturbance that developed from an area first observed over the Bahamas on Sep. 10, 2020, growing to a wide area of low pressure and raising its indication to a tropical depression on Sep. 11, 2020. On Sep. 12, 2020, the tropical depression strengthened into Tropical Storm Sally. On September 14, Sally was upgraded to a Category 1 hurricane and, on September 15 a Category 2 hurricane.

NWS data indicated that Hurricane Sally made landfall as a Category 2 hurricane on Sep. 16, 2020, at 09:45 UTC near Gulf Shores, Alabama at peak intensity with maximum sustained winds of 110 miles per hour. The storm rapidly weakened after making landfall and was downgraded to a Category 1 hurricane at 13:00 UTC, then to a tropical storm at 18:00 UTC. It later weakened to a tropical depression on Sep. 17, 2020, at 03:00 UTC as Hurricane (now Tropical Storm) Sally made landfall. Storm surge of more than five (5) feet was reported in some coastal areas and flooding was pervasive with rainfall calculated at over 20 inches. Loss has been estimated at over 7 billion dollars.

The intensity of a powerful storm event, for example a tropical storm or hurricane, is measured by the Saffir-Simpson Hurricane Wind Scale (SSHWS) into five categories. This rates the storms from one to five based on speed of sustained wind in an area signifying the potential untoward effects high winds can cause. This table is detailed below in table 1.

| Hurricane Category | Wind Speed in Miles Per Hour (mph) | |
|---|---|---|
| 1 | 74-95 | mph |
| 2 | 96-110 | mph |
| 3 | 111-129 | mph |
| 4 | 130-156 | mph |

| | |
|---|---|
| 5 | Above 157 mph |

In the case of Hurricane Sally, documented wind speeds in the vicinity of the subject property during the event reached a maximum of 74 miles per hour while the three-second wind gusts reached as high as 92 miles per hour. The storm event resulted in rainfall of approximately four (4) to five (5) inches in the vicinity of the subject property.

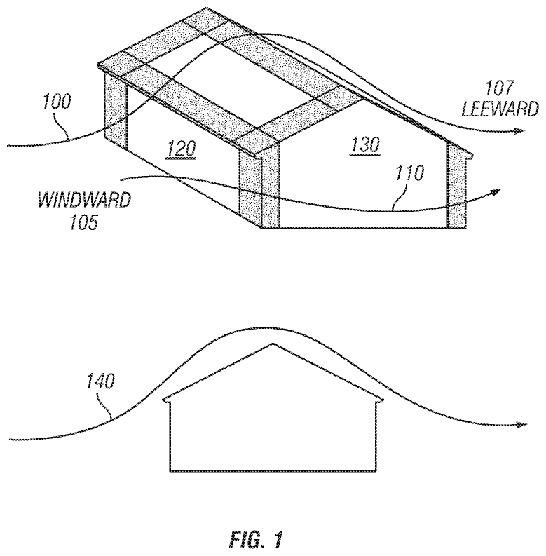

In terms of wind direction, Minimum Design Loads for Buildings and Other Structures published by the American Society of Civil Engineers (ASCE 7), the term “windward” indicates the face of a structure that experiences direct wind pressures whereas “leeward” indicates the face of the structure opposite the windward face as illustrated in FIG. 1 which is highly dependent upon the orientation of the structure. Wind direction is a vital aspect of a forensic investigation in terms of its causative relation to wind rain and wind-rain-hail activity, particularly as it relates to water intrusion, potential windborne debris impacts, and anticipated loads especially for those inspected impacted elements directly facing incoming high-velocity winds. For instance, windward pressures on an enclosed structure (positive pressure) will push fenestrations (i.e., fixed panel, sliding glass doors, casement and storefront) toward the interior, while leeward pressures on an enclosed structure (negative pressure or suction) will tend to pull fenestrations toward the exterior. The roofs of structures as well experience windward and leeward pressure, depending on pitch, but also experience uplift pressures. The following FIG. 1 herein depict the pathways of wind around a hypothetical structure, with zones of highest wind pressure existing at the building corners as well as at the roof eaves, rakes, and ridges wherein wind seeks the lowest resistance to force. Yet, the leeward side of the structure is no less instructive, at a minimum, for its comparative value against the windward side of a structure.

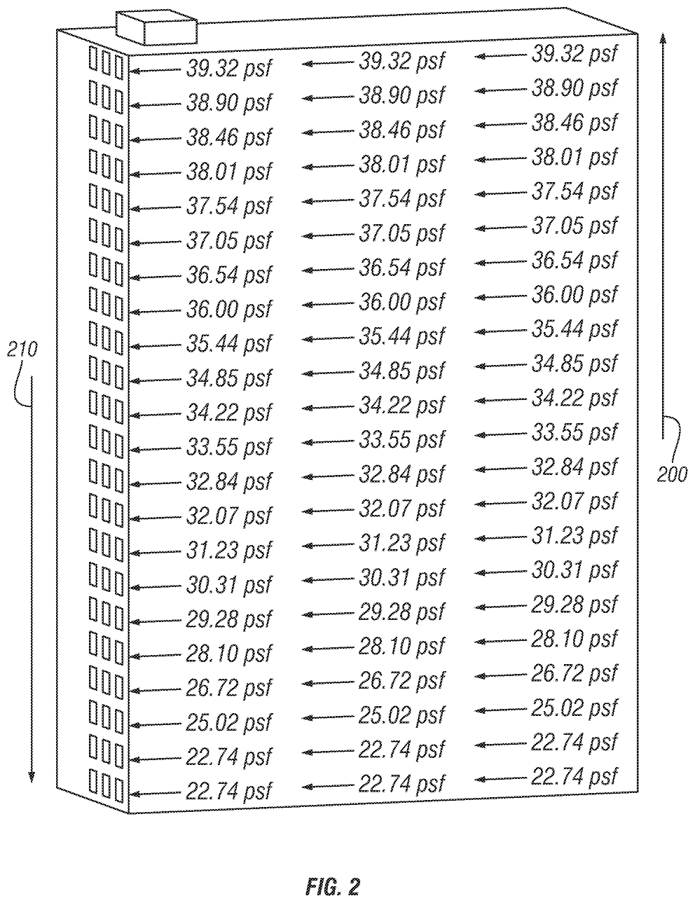

In addition to the understanding of lateral wind loads detailed in the preceding paragraph, it is important to understand the effects of wind that vary with building height on taller structures, such as mid-rise and high-rise structures. The following FIG. 2 herein depicts calculated design wind pressure trends on the wall surfaces of a representational high-rise structure, based upon the American Society of Civil Engineers' ASCE 7 describing Minimum Design Loads and Associated Criteria for Buildings and Other Structures (hereafter “ASCE 7”). Calculations were based upon the 2005 version of ASCE 7 using a design wind speed of 130 miles per hour, which is a common design wind speed for coastal areas. It should be noted that depending on the item being modeled (components and cladding, roof, walls, etc.), the calculations vary. Regardless, the purpose of including the graphic is to demonstrate common wind pressure trends, such as the expected increase in wind pressure with height on the windward side of a building. The graphic is not intended to represent actual pressures associated with any storm event, including the reported storm event, and is not site-specific.

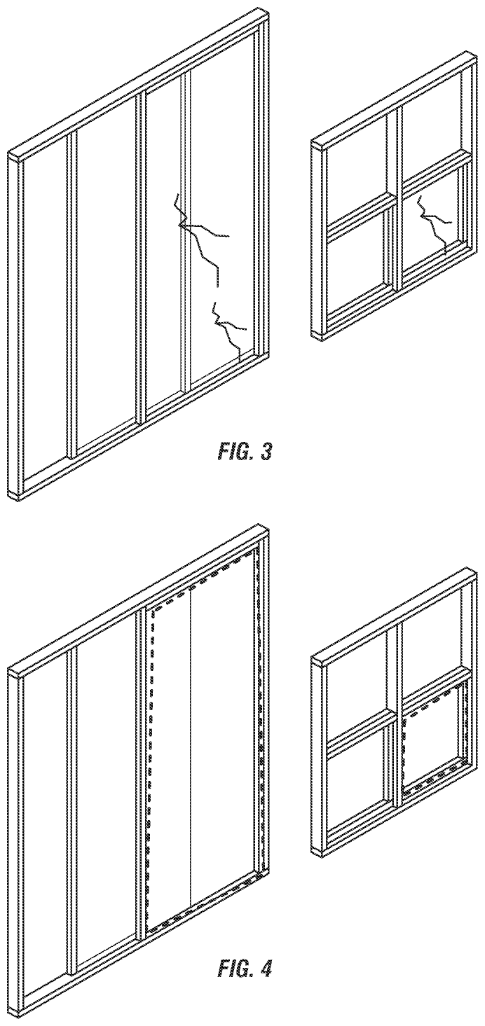

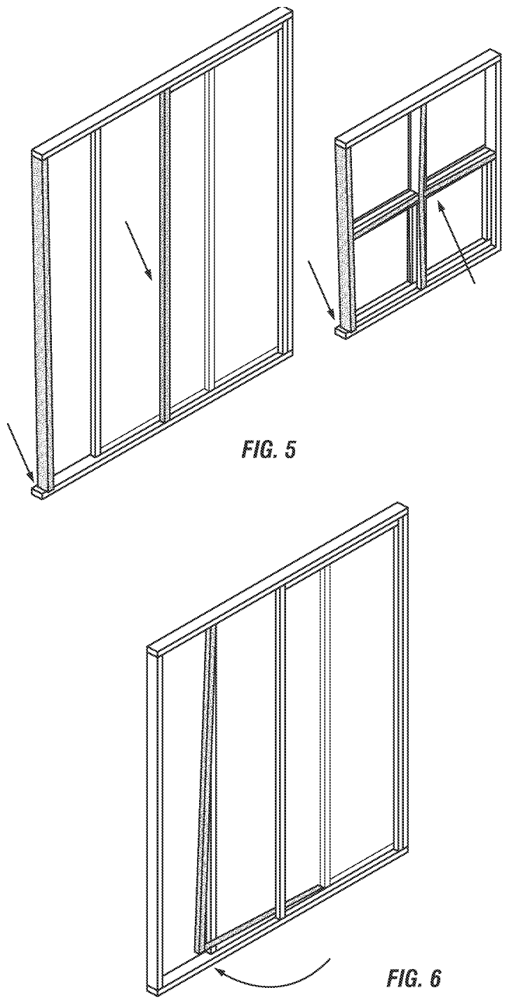

Adding to water penetration, wind-related distress conditions to glazed fenestrations can include the following, related to wind pressure and/or windborne debris impacts, including fractured glazing, loose glazing, fogged glazing and/or scratched or etched glazing. As depicted in FIG. 3, fractured glazing can appear on windward exposed fenestrations which evidence either fractured glazing, loose or fogged glazing (see FIG. 4). In addition, the frame surrounding fenestrations may become dented, bent or bowed, broken or separated from windows and doors, frames may be dislodged and/or scratched as a result of high winds and debris. Some examples of said frame's altered conformations is evidenced in FIGS. 5 and 6.

### Conditions Descriptions

With reference to FIG. 1, wind and wind direction, the present invention is informed by information gathered denoting primary wind direction(s) (100, 110, and 120) and windward 105 disposed building facings (north, south, east, west or a combination thereof), illustrated here as 120 and 130, including all wind-facing areas of a structure's façade and wind experienced at each elevation on multilevel structures). Equally informative are areas of leeward wind 107 wherein direct wind force is not experienced by a structure. FIG. 2 displays representational pounds for square foot (psf) of received wind force or pressure wherein those fenestrations and structural components of a building existing at higher elevations 200 receive greater wind velocity than those residing at lower wind elevations 210, as a general rule. Therefore, perceived wind velocity may be said to increase commensurate with increased heights.

Fenestration Wind Assessment (FWA) may be the most informative of all inspection driven assessments. In the case of a multi-level structure, fenestrations and fenestration assemblies (frames) are inspected both externally and internally (where access is permitted). External inspection, especially exteriorly and at increased heights may be achieved thorough use of a remotely controlled drone. What is more, this same drone may be used to provide an aerial view of roofs and roof elements (air conditioning, HVAC, water treatment equipment) for conditions assessment.

Said fenestrations and contiguous fenestration assemblies are inspected for conditions attributable to the effects of wind, hail, water and debris, including but not limited to fractured glazing, fogged insulated glazing (if present), displaced/disconnected elements, scratched (etched) glazing, as well as dented and/or abraded frames. These conditions are notable for their existence as much as for their extent, shape, location as well as location to other similar and dissimilar conditions. Additionally, the absence of these conditions on fenestrations and fenestration assemblies, in spatial relation to other conditions or non-conditions, gives a clearer picture of a change in an element's conditions due to an event versus condition changes resulting from wear, corrosion, age-related deterioration, improper installation or man-made conditions in a completed spatial analysis model (SAM) process.

Specially, refereeing now to FIG. 3, broken glass in fenestrations is indicative of wind or storm-related condition changes wherein, encased glass is assumed to be unbroken prior to an event. Yet, after an event, especially those events (e.g., hurricanes) involving high wind velocities, hail and subsequently generated aerial debris, resultant broken windows and doors, with or without water (rain) infiltration, is highly suggestive of a destructive causative force. Yet, this must be tempered with the knowledge that glass breakage can be traced to other causative origins indicative to the inherently fragile nature of glass. Other causes may include thermal stress (resulting from a temperature gradient between the inside of a partitioned area and the outside), window size and orientation (large or narrow windows exhibiting uneven distribution of weight whereas small square windows experience less stress due to even distribution and force across smaller areas, in general), defective edges (whether during the manufacturing, storing, transportation, or installation process) where windows can receive scratches and chips and, if unnoticed at the time of installation, can result in spontaneous breakage as the glass contracts and expands during temperature changes), and improper installation (considering many factors that when installing windows, such as the pane's dimensions, stress, and pressure, these influence the safety of the window as additional pressure on certain portions glass or frames can increase the likelihood of breakage). Therefore, although broken glass in windows and doors is highly suggestive of a significant weather event related to condition changes, it is also prudent to consider, in certain cases, other factors that may be responsible for changes in condition or, in other cases, contributory factors to glass breakage.

Further, in FIG. 4, fractured glazing is of particular importance in determining the extent of event derived conditions or changes in condition attributable to wind, hail and rain. Fractured glazing offers a key insight into changes in fenestration condition or conformation, water infiltration, or a combination thereof, as well as surrounding documented conformational changes, where said fractured glazing results from windborne debris or wind-induced pressure and force. Specifically, fractured glazing conditions documented on the windward elevations (see FIG. 2) could reasonably be attributed to wind while similar conditions on the leeward elevation(s) or lower elevations can be reasonably attributable to other undetermined cause(s) not directly related to wind facilitated debris.

Too, fogged glazing may be related to wind and/or wind generated pressure wherein “fogging” may exist due to conformational changes to windward facing fenestrations and their assemblages. Although, if fogging exists reasonably equal to fogging on the leeward side of a structure, comparatively, said fogging may be attributable more to wear, age or installation given a uniform distribution (where fogged conditions exist in all global directions). And, where fogging is consistent between higher elevations and lower elevations, and, as above higher elevations typically experience higher wind velocities, fogging due to event-induced wind is presumed to occur at a larger rate in both windward facing fenestrations and higher elevations and upper floors compared to leeward facing fenestrations and lower elevation levels. Therefore, fogging occurring uniformly across a building's façade, or uniformly between upper and lower-level glazed fenestrations, would indicate non-weather event related wear, age or improper installation.

Describing fogging, especially with advanced age, double-glazed fenestrations are designed to provide an insulation barrier at a scheduled opening in a wall, between the interior climate-controlled air and the exterior air, to help minimize energy demand and condensation. Condensation occurs when water vapor within relatively warm, moist air turns to a liquid phase or condenses on relatively cool surfaces, which often occurs at fenestrations. Over time, water vapor from exterior air enters the cavity between two glazing panes due to deterioration of the glazing seals and/or movements of the unit from exposure to normal environmental conditions such as cyclical temperature changes and ultraviolet radiation. For this reason, a track of desiccant, or moisture absorbing material around the perimeter, is sometimes installed within the airspace between double-glazed panes to remove moisture. Eventually, over time, the desiccant becomes saturated and can no longer absorb moisture. Soon thereafter, moisture vapor will condense on the interior surfaces of double-glazed fenestrations and will become visible. In addition to age-related conditions, defects can exist in the glazing seals and/or improperly installed windows, doors or fenestration assemblies that could contribute to fogged glazing conditions wherein a destructive investigation may be required.

Too, scratched (etched) glazing can be indicative of abrasions due to event-induced windborne debris, furniture interaction, occupant interaction upon entrance and egress, window washing efforts and past maintenance or repairs. Generally, scratched glazing does not limit the function (weatherproofing) nor life expectancy of the glazing system and, depending on the size, may or may not be noticeable by occupants or requiring repair. American Society for Testing and Materials' ASIM C1036 Standard Specification for Flat Glass details quality requirements, including blemishes such as scratched (etched) panels, in newly installed glazing applications such as the fenestrations at a subject property. While ASTM C1036 is intended to be an acceptance guide for new glazing installations, the methodology and criteria therein can be adapted as an aid to an assessment of in-service fenestrations. According to ASTM C1036, architectural glass products such as the glazing utilized at the subject property, are classified as Quality-Q3 (cut-size or stock sheets). Therein, blemish intensity is quantified to provide a baseline for allowable blemishing, which directly correlates to scratches (etching) which was considered wind during the reported event as a potential cause. It should be noted that the blemish intensity of the majority of scratched (etched) glazing conditions identified during inspection may be classified as “Faint” to “Light,” which is allowed in new glazing installations of Quality-Q3 glazing and can be therefore excluded from the SAM assessment. As such, only instances of scratched (etched) glazing that met the blemish intensity criteria of “Medium” or “Heavy” may be documented in the SAM process (if present) at the request of the client or administrator. Additional information regarding the processes and/or procedures for inspection of glazing systems for blemishes (including but not limited to scratches) can be found in ASTM C1036 and has been further documented in a number of peer-reviewed professional technical publications. It is therefore similarly important to judge the location, extent and condition of scratching in terms of degree and intensity and whether those conditions exist on windward or leeward sides and/or at lower or heightened elevations as to determine causality and requirement for removal and replacement. Further, is in instructive to observe the distribution of conditions, grouping of conditions and relativity of each condition (or absence of a condition) in relation to all other conditions.

As proved in FIGS. 5 and 6, fenestration frames hold additional value when assessing the damaging effects of windborne and, subsequent or concomitant, rain borne conformational changes to a structure and structure's interior, to a property or a combination thereof. Instances of bent (dented) or broken frames are potentially attributable to windborne debris impacts associated with a significant weather event and can provide a directly attributable source for water infiltration into a structure. Specifically, changes in conformational configuration (bent or bowed) frame conditions documented on the windward elevations of a structure could reasonably be attributed to wind while similar conditions on the leeward elevation(s) can be reasonably attributable to other undetermined cause(s). Dislodged frames also have an increased incidence of water allowance into a structure where gaps or spaces created between a fenestration frame and rough door opening or doorjamb allow water to enter the structure. While less likely to cause separation (and subsequent water infiltration), door frame scratches and abrasions remains indicator of debris contact with a door especially when coupled with other conformational changes in elements (warping, bending or dislodging) as an indicator for fenestration and/or fenestration assemblies' allowance of water and moisture to enter a structure.

As alluded to above, various moisture exposure condition(s) may be associated with the fenestrations—fractured or intact. The present invention is utilized to capture the nature and extent of moisture-related condition(s) at the fenestrations using the SAM process. It should be noted that instances of fractured glazing and/or displaced frames (if any), should be considered storm-created openings that allow for water penetration, while water penetration that occurred through intact fenestrations should be considered the result of wind-driven rain (WDR). In addition to wind-related cause(s), moisture conditions were also attributable to other potential cause(s), such as condensation, age-related deterioration, installation deficiencies, occupant activity (windows left open and/or unlocked during rain events), and the like, wherein any combination of compromised fenestrations and structurally sound fenestrations may cause both water and moisture infiltration into the same structure.

Wind-driven rain (WDR), as provided above, is defined as moisture that penetrates a scheduled opening, facilitated by a corresponding wind element, absent of any storm-created opening(s) (fracturing), and for which no repair to the opening components would be required following the event. According to the FEMA Local Officials Guide for Coastal Construction, water penetration through an unscheduled breach (storm-created opening) in the building enclosure is typically greater than that associated with wind-driven rain through a scheduled opening, such as an intact door or window. Wind-driven rain is expected to occur at doors and windows during Hurricane events due to the Water Penetration Resistance Rating (WPRR), which is typically 15 to 20 percent of the structural pressure rating of the window assembly, depending on the performance grade of the unit. This is confirmed by the FEMA Local Officials Guide for Coastal Construction and by AAMA/WDMA/CSA 101/I.S.2/A440, the North American Fenestration Standard/Specification for windows, doors, and skylights.

Expressly, hurricanes, coastal storms and other significant wind and rain events have a high propensity to cause water infiltration due to both Strom Created Opening (SCO) and Wind-Driven Rain (WDR). And, contrary to perceptions, fractured glazing is not the sole mechanism of water penetration where wind speed above 35 to 65 miles per hour may cause water infiltration into a structure, absent fracturing, dependent upon Water Penetration Rating (WPR) of the assembly wherein penetration does not necessarily constitute failure or conformational changes in a fenestration or assembly. Even without an afront to glazing, leakage can occur between the door or window and their frames and between the door/window frames and their contiguous walls. It is anticipated that the intensity of the wind will routinely exceed the manufacturers maximum ratings by creating high-wind pressures on the outside of buildings, bypassing closed fenestrations and exploiting their weakest point (e.g., those areas around doors and windows). Even otherwise intact windows may allow a certain amount of infiltration, those windows and doors exhibiting wear or those units that were improperly installed, may exacerbate this water entry and allow more passthrough than an otherwise new or properly installed window or door. This Storm Created Opening (SCO) and Wind-Driven Rain (WDR) must be additionally differentiated from historical water infiltration and/or ongoing water leakage or exposure which is characterized by deteriorated, rotted/corroded, and/or disintegrated finishes and framing. Therefore, certain considerations are warranted for fenestration condition and proper placement when assigning causation (and ultimately monetized through claim settlement).

Consequently, anywhere breaches at or near fenestrations (ex. fractured glazing, dislodged framing) occur, resultant water penetration during a high-wind and rain event is expected where there exists a low threshold of entry. And entry through intact fenestrations is anticipated where high-force winds nonetheless overcome even the “sealed” passive resistance to rain entry resulting in moisture exposure condition(s) to interior element(s).

In addition to fenestrations, other vulnerable elements on balconies may be used to conduct a balcony wind assessment (BWA) to determine (1) localized conformational changes and (2) to gain an expanded view of conditions existing at proximate locations and distal locations from the element under review. Specifically, guardrails, flooring (i.e., tile), light fixtures, outlet covers, vent covers, exit signs and fire safety equipment are inspected, photographically documented and annotated.

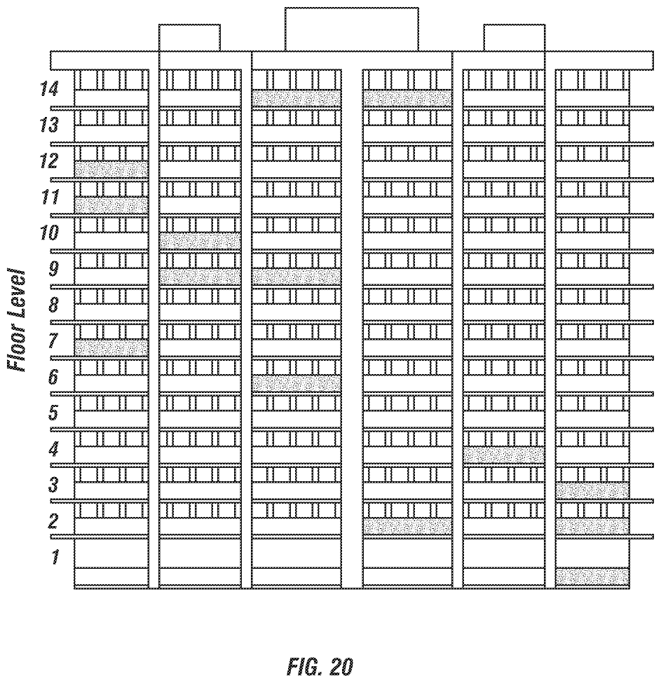

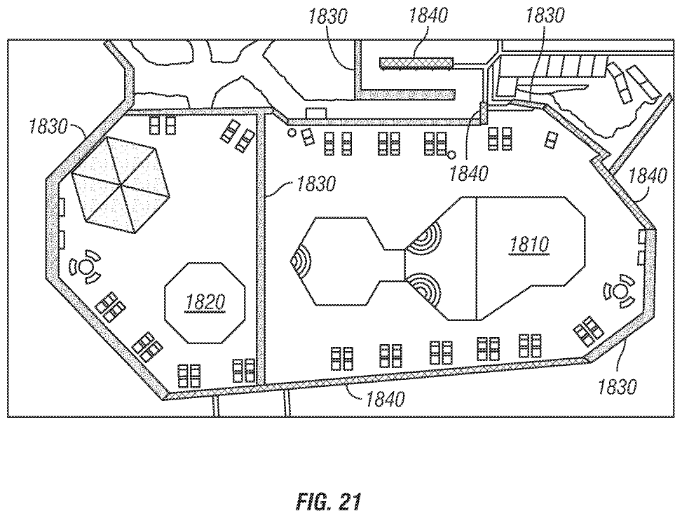

For example, as depicted in FIG. 20, under the BWA, guardrails may be inspected on various exterior balconies for conditions attributable to the effects of wind, such as abraded, scratched, bent, broken, disconnected, missing, and/or loose guardrails and related hardware. Conversely, conditions such as hairline scratches on the top of rails, corrosion, rust, peeled coatings, and the like may be documented yet determination of origin of conditional changes may be more attributable to normal wear than causes due to wind, rain and debris.

Further, flooring, expressly tile on the exterior of the building existing on balconies, may be inspected and its conditions documented for fracturing or missing tiles wherein conditions change due to weather events may be excluded where tiles were aged, worn or installed improperly.

Fixtures, ex. light fixtures, or absence thereof, and their conditions of disrepair may provide additional evidence of the existence of weather induced or facilitated high wind forces and/or debris. Fractured, loose or missing vent covers, outlet covers, exit signs and fire safety equipment (fire extinguishers, fire pull stations and water hoses) equally provides corroborating evidence of high winds and/or debris causing conditions or changes in conditions due to hurricane force winds. In opposite, no observed and documented evidence of conditional changes or missing parts to these elements would answer the question of weather event related wind conditions in the negative.

Further, areas lying outside, and in the immediate area, of a structure may also indicate that a property's structure was subject to high-force winds, hail, rain or a combination thereof. Here, areas in and around a common area/swimming pool area, typically facing the ocean, provides further documented evidence indicating high wind and/or existing debris conditions particularly at lower levels of a multi-story building. Specifically, guard railing existing around a swimming pool area will typically exhibit conformational changes in the form of bent or broken banisters, pickets, fence caps and fence posts, as well as other lost, broken fence hardware (See FIG. 21). Absence of such conditions, or conditional changes that does not find some congruence with wind, hail or rain, may provide additional evidence that resultant conditions may not be due to a particular weather event. Also, conditions to guardhouses, parking lots, parking garages, tennis and basketball courts, BBQ areas, hot tub areas, contiguous grounds and structures surrounding a central structure (e.g., a condominium) may serve an evidentiary role in determining the impact and extent of a wind/hail/rain event or its preclusion.

Too, a secondary effect of direct high velocity winds applied to a structure's exterior, especially fenestrations and frames, as in the example of Storm-Created Openings (SCO) and Wind-Driven Rain (WDR), may be used to differentiate gathered and collected data distinguishing weather-related conditions from conditions attributable to other sources (plumbing leaks, historical conditions). In addition to wind-related cause(s), moisture conditions may also be attributable to other potential cause(s), such as condensation, age-related deterioration, installation deficiencies, occupant activity (windows left open and/or unlocked during rain events), which should be considered taking all circumstances and spatial relationships of conditions into consideration.

Ultimately, though, certain conditions existing at the time of inspection may be of an undeterminable origin and conditions due to wear, age, installation and event-related conditions may be so closely aligned, or of a duplicative nature, as to disallow a determination of causation. Yet, taking inspection results in totality, gathering evidentiary data from all inspected units, subunits or areas, even taking into consideration those units or areas with undetermined causative conditions origins, lack of causative correlation is greatly diminished by considering conditions manifested in all windward, leeward and surrounding spatially related areas. Once those conditions have been inspected and documented, a determination on causation may be reached wherein conditions may fall into a binomial category of event-related conditions and non-event-related conditions in all but a small percentage of weather-related conditions events.

### SAM Inspection Process

With regards to the present structure and property, a site-specific spatial analysis model (SAM) is developed by taking measurements of the property, collecting information via visual inspection and data collection, incorporating weather and time data information collected from above meteorological sources, and/or publicly available and/or accessible images both pre and post event (where available). Items that obstruct the view of inspected elements, such as columns, elevators, screen walls, stairwells, parking garage(s), etc., may be removed as needed from the final SAM (or certain depictions) to improve visibility. The SAM spatial analysis includes an assessment of the nature, frequency, and location(s) of various documented conditions as to provide an inclusive analysis of condition(s) causation taking into consideration a structures orientation, windward-facing sides and elements and leeward sides and elements. The various conditions are then compared to documented conditions in the vicinity of the subject property associated with the storm event, such as wind velocity and direction. Any correlation (or lack thereof) of various conditions and documented storm data is noted for consideration. For example, special note is made of a condition or conditions (broken or fogged fenestrations) that occurred predominately on windward-facing elevations and/or conditions to windward-facing representationally vulnerable elements (e.g., guardrails, exit signs, light fixtures, vents) which could reasonably be attributable to the effects of wind, taking president in the present invention, while a condition that occurred randomly throughout a property, regardless of orientation to a wind event, would reasonably not be attributable to a one-time weather event with omni-direction wind gusts.

The SAM administrator/operator then collects and processes digital images, transcribed verbal description and written descriptions of post-storm conditions at the subject property, which are retained in a historic repository and may be relied upon at a future time. And, while some conditions identified during inspection may have been pre-existing, however, absent photographic or documentary evidence, the administrator/operator of the present invention cannot completely exclude or include all such conditions as non-storm related or storm-related conditions that occurred during the specific reported event. Detailed notes regarding the nature and extent of the above conditions, as well as other verbal and transcribed notes, are included in the final interpretation and analysis which indicate whether each condition, or collection of conditions, may be attributable to a single cause or causes, directly or indirectly.

In terms of data gathering and input, the current system relies upon one to a plurality of technicians, working singly, in pairs or teams, depending on the anticipated SOW, requisite detail and time allowed for data collection and input. Taking for example a single of team of two individuals, one technician may be responsible for data input (unit location, conditions type, conditions location) and transcribing verbal analysis into written annotations while the second may be tasked with gathering visual evidence to be linked to the data input, for example.

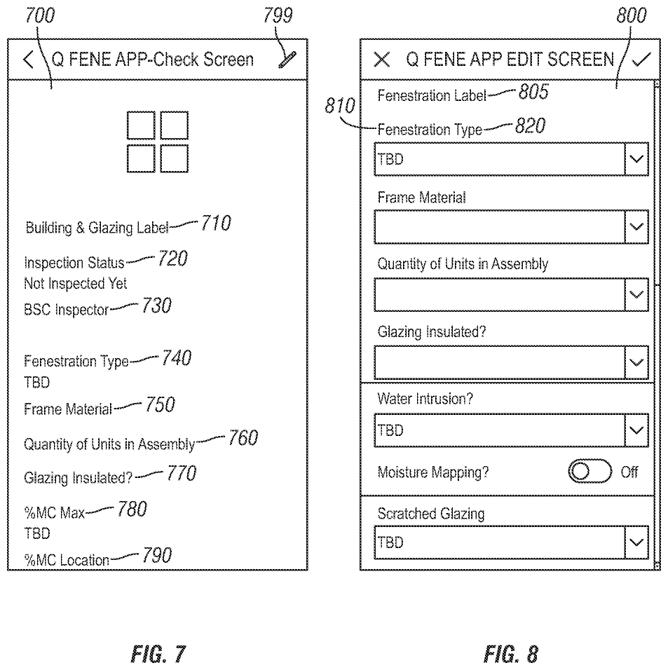

As depicted in FIGS. 7-16, a technician may utilize a graphic user interface (GUI) installed on a mobile device (smartphone or tablet) giving the operator a guided dropdown menu with both informs subsequent data categorization, organization future labeling, access and accessibility.

Referring to FIG. 7, the operator or technician user first encounters an App-Check Screen 700 presenting a building designation & glazing label 710, inspection status 710, inspector identify 730, fenestration type 740, frame material 750, quantity of units 760, presence or absence of insulation 770, % MC (moisture conditions) max 780 and % MC location 790 denoting pertinent information involved with inspection. The user may then access the Q Fene App Edit Screen 800, FIG. 8, guiding the user to a field denoting a fenestration label 805, by selecting the edit pen 799 to access this area. This screen consists of various drop-down menus which are selectable and/or editable by the user and editable by the administrator or programmer to support the type of inspection being conducted. Here the configuration is compatible with a fenestration inspection. Once the edit pen 799 icon is selected, Q Fene App Edit Screen 800 is then accessible to allow the user to select the particular fenestration type 810 encountered and observed where said fenestration type in FIG. 8 is TBD (to be determined) 820 prior to selection.

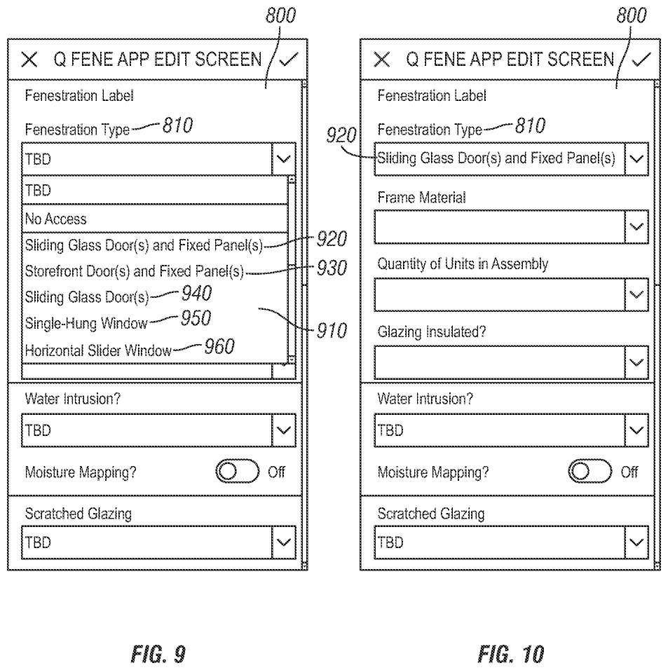

Once fenestration type 810 is accessed, a dropdown screen 910 is presented to the user (see specifically FIG. 9) allowing the user to select the type of fenestration being observed and inspected including choices: sliding glass door(s) and fixed panel(s) 920, storefront doors and fixed panels 930, sliding glass doors 940, single-hung window 950 and horizontal slider window 960 from which to select an option.

As shown in FIG. 10, the user has selected sliding glass door(s) and fixed panel(s) 920 on the Q Fene App Edit Screen 800 from the dropdown 910. User may then scroll, down, pivot, designate or be prompted to the second dropdown selectable field, Frame Material 1110.

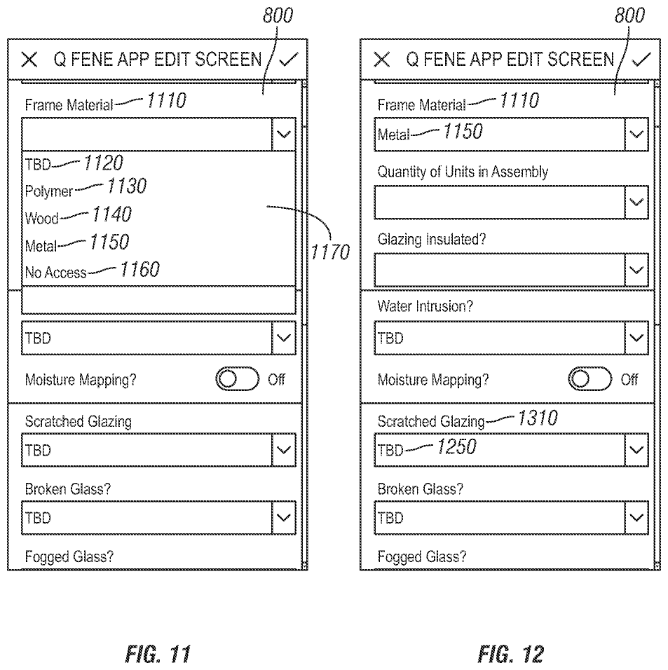

Turning to the next selectable dropdown field 1170 in FIG. 11, Frame Material 1110, several designations become apparent: the default Frame Material TBD 1120, Polymer 1130, Wood 1140, Metal 1150 or No Access 1160. As evidenced in FIG. 12, the user has selected Metal 1150.

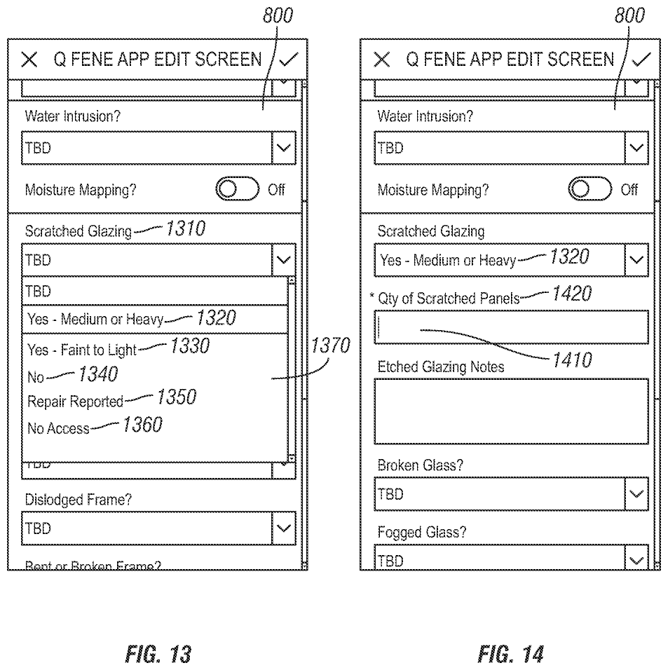

Next, the user is either prompted to advance to Scratched Glazing 1310 or moves of his or her own volition to Scratched Glazing 1310. As in FIG. 13, a dropdown screen displaying TBD 1250 is the default setting. Once Scratched Glazing 1310 dropdown menu 1370 is accessed, selections Yes—Medium to Heavy 1320, Yes—Faint to Light 1330, No 1340, Repair Reported 1350 and No Access 1360 are displayed. As shown in FIG. 14, Yes—Medium to Heavy 1320 is selected and displayed and cursor 1410 of field Qty of Scratched Panels 1420 (designated with an “*”) provides a hard halt for user to designate the number of Scratched Panels 1420.

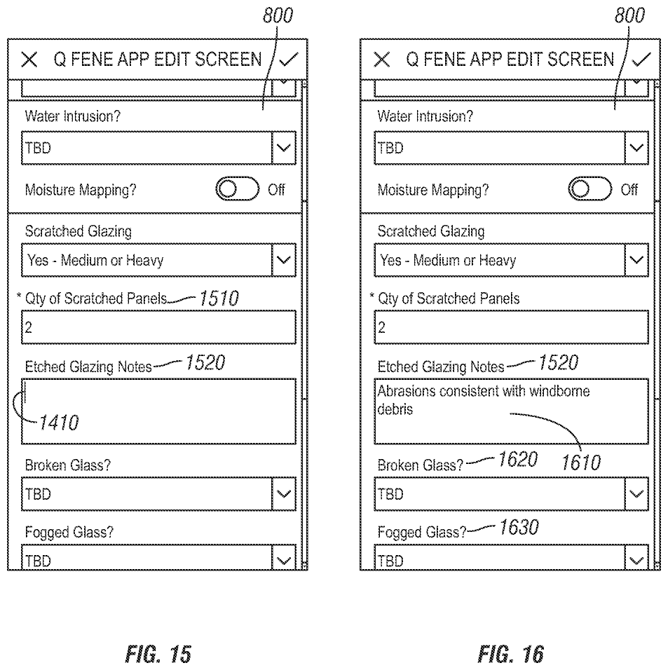

User thereby indicates the number of Scratched Panels 1420 is two (“2”) 1510, in FIG. 15, prompting cursor 1410 to move to the next selectable/editable field, Etched Glazing Notes 1520, whereby user may indicate and annotate the user's description of the conditions type, severity of condition, location of condition or other relevant descriptive elements in the provided field 1610. Similar steps may be taken as to described broken Glass 1620, Fogged Glass 1630, frame conditions and/or water existence or absence (not shown) or any other condition precedent deemed informative to the inspection process.

Thereafter all forms of data input may be reviewed and edited by an administrator/operator as to verify quality of information, completeness of information and/or requirements for additional data points to provide a more complete analysis of a particular area, unit or subunit. Thereby the visual collected data and written descriptions may be collected separately, packaged and made accessible and assessable at a single information unit wherein the end user may access a complete description of conditions either (1) in a single area, unit or subunit or (2) comprehensively throughout the entire structure. Of particular importance to the present invention is the use of a combination of micro scale data collection and analysis of areas units and subunits in conjunction with a conglomeration of data in sum total. These interdependent analysis allows for a granular assessment of single points or grouped conditions and a “birds-eye” view of conditions received (or absent) across an entire structure.

Photographic data, transcribed verbal data and annotated written descriptions which are observed, recorded and collected by technicians at a designated inspection site or area may then be categorized and compartmentalized into separate categories of conditions (e.g., conditions to fenestrations, guardrails, ancillary external structure elements) and made accessible to an information consumer via an instructible and programmable software platform for categorization and display of collected information. The computing devices themselves include operative hardware existing on conventional computer devices or apparatuses including one to a plurality of central processing units (CPUs), volatile and non-volatile memories to a plurality of storage memories (RAM, ROM or both) within a single device or across several devices, computer readable and writable media, various input/output portals and circuitry compliant with universal standards and protocols as well as wired and wireless communications and networking capabilities for transfer of information and cloud storage all known in the art. In certain cases, functional components of the computing system may be in a single unit, across several units or a networked collection of hardware and software devices and programs.

Components suitable to carry out certain functions (hardware, software, firmware or a combination thereof) found in known conventional computing devices may be utilized in a single device or across several devices operative application software such as network software for communicating with other computing devices, database software for building and maintaining databases, and task management software for distributing the communication and/or operational workload amongst various CPU's. Software may include operative application software such as network software for communicating with other computing devices, task management software for distributing the communication, database software for building and maintaining databases, and/or operational workload amongst various CPUs to collect, record, process, categorize and display conditions analysis information.

### Data Presentation

Once all points of inspectable data have been identified, inspected and collected and all pertinent conditions data has been collected and entered into the SAM system, data is presented in visualizations (2-D or 3-D representations or model) of a structure whereby conditions may be viewed on a unit-by-unit (or area-by-area) basis or across an entire structure giving both micro and macro scale accessibility to a consumer of event-related conditions.

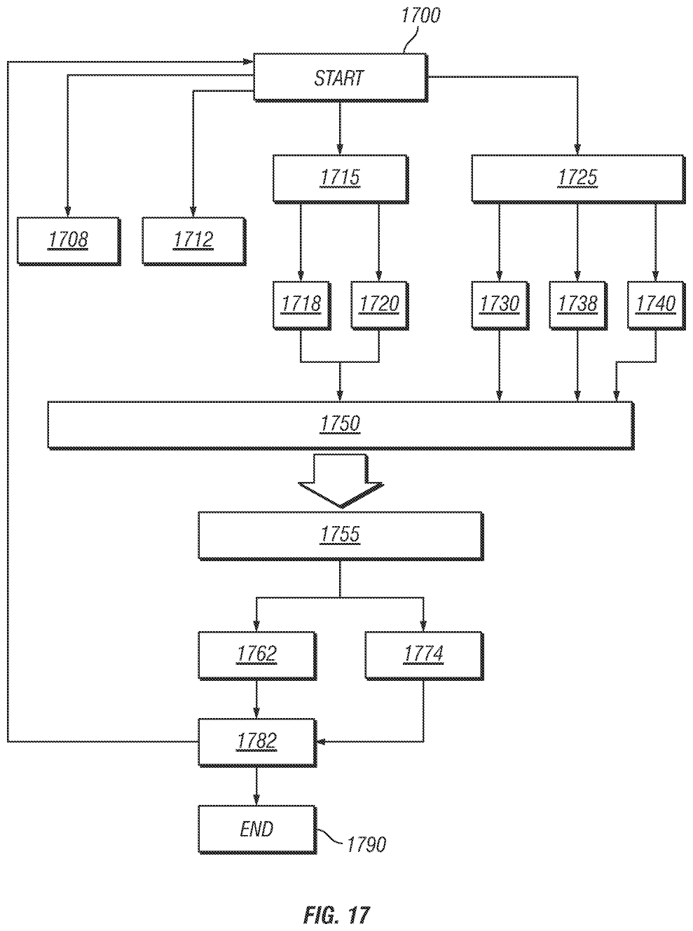

As depicted in FIG. 17, a method is presented which describes the SAM process and method for accurately inspecting, collecting, and recording data by a technician or plurality of technicians, compiling and processing data and presenting conditions data to the ultimate consumer.

Processing begins at START 1700, whereby meteorological data 1708 and time data 1712 is gathered to establish an event (e.g., significant wind/rain/hail weather event). The metrological data 1708 is significant in that this data provides the basis and context for all conditions assessment inspections and the time data 1712 creates the initial timeline by which an inspection is guided and metered (providing initial times, peak wind/rain/hail and finishing time for a wind/rail/hail event).

Publicly and privately available data 1715 is collected in the form of image data 1718 and descriptive data 1720 which may be held in governmental databases (e.g., titles and transference), publicly, and property owner data bases, privately in the form of deeds and property descriptions.

Finally, inspection data 1725, the key elements in the functioning of the present invention, described in FIGS. 3-16 are collected, compiled and processed, along with meteorological data 1708 and time data 1712 and publicly and privately available data 1715 (in the form of images 1718 and descriptions 1720) to compile a ‘SAM’ forensic analysis from all gathered data in which conditions are either assessed to be weather event-related, non-weather event related or non-determinate. Said analysis and results are compiled into a Final Forensic Analysis Report 1755 whereby information is categorized into both a visual format 1762 and a written format 1774. Said visual format 1762 and a written format 1774 are then integrated into a single database 1782 for interrogatory and consumer access where visual displays exist for inspection access, inspection completion, micro and macro conditions visualizations, micro and macro written conditions assessments, overall conditions assessments and results related to potential conditions causation, most probable conditions causation and actual conditions causation. And finally, once the database has been established, the method finalizes at END 1790. It should be noted that the results gathered and presented in data base 1782 may be “reinformed” and “reprocessed” with the inclusion of new or additional information.

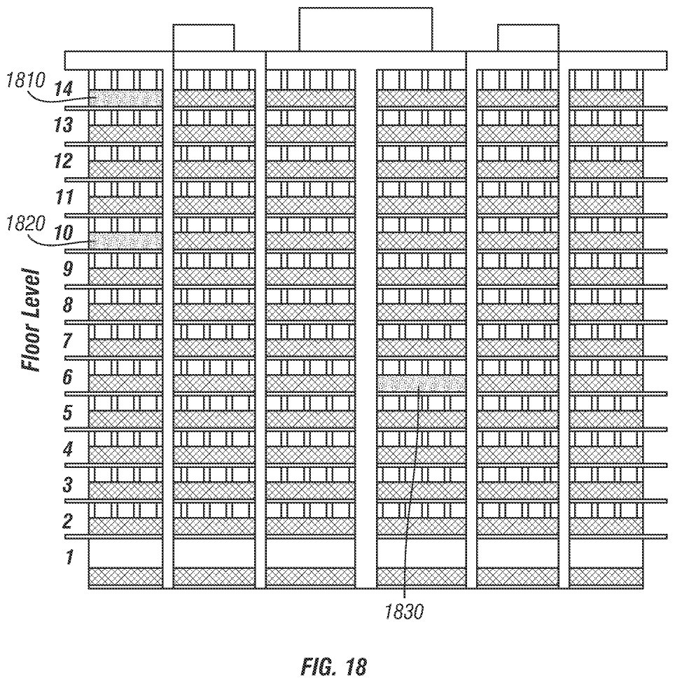

As provided and illustrated in FIG. 18, individual units may be designated as inspected, not inspected or access denied or unattainable which may be designated by color coding or highlighting, or, in the case of FIG. 18, as stippling, hatching, cross hatching and the like. Furthermore, designations may be made using similar nomenclature denoting the existence, nature and area of conditions. Specifically, units 1810, 1820 and 1830 exhibit stippling as to indicate units which were not accessible to inspectors, but such indicators could just a readily be utilized to signify conditions, and changes of conditions, to balconies, guardrails or practically any exteriorly residing or facing element.

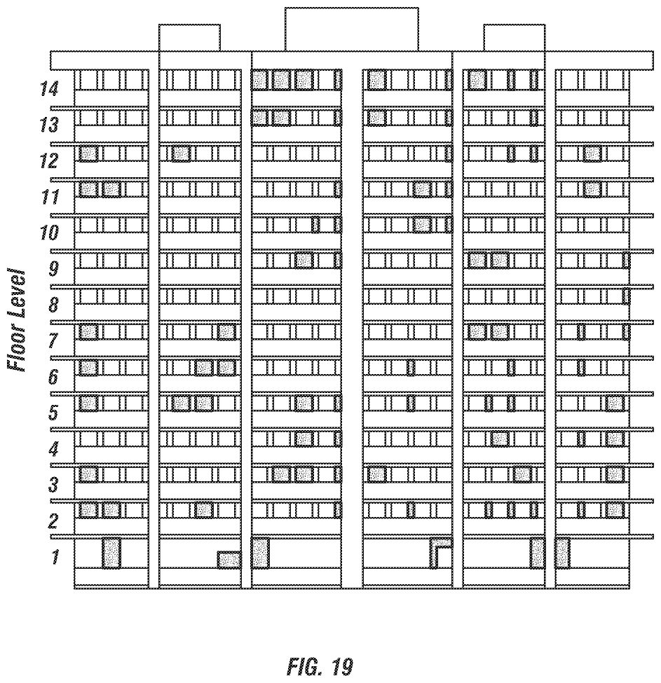

As shown in FIG. 19, fenestrated areas exhibiting conditions, changes in conditions, or lack of conditions or changes, may be signified with coloring, highlighting, shading, stippling, hatching, bolded lines, shading or any other visual means differentiating areas affected (fractured, fogged or scratched fenestrations) from non-affected areas. In the case of FIG. 19 this is achieved with bold outline and stippling. Taken in their entirety, this representation not only allows the information consumer the opportunity to visually interpret inspected and non-inspected areas (see FIG. 18), but also the results of an inspection (i.e., areas of fenestration conformational changes). Manifestly, whereas FIG. 18 signifies inspected unit fenestrations, FIG. 19 affords the information consumer the ability to interpret the results of the inspection and conformational changes directly effecting fenestrations.

FIG. 20 depicts areas of effected guardrail conditions (displayed through stippling) whereby areas of bent, broken or displaced guardrail elements may be signified, for example, with a visual aid giving the information consumer specific optics for individual units, clusters of units (here depicted by stippled fill). Although, the representation with stippling could easily be equally accomplished with outer means of differentiation described above.

Too, FIG. 21, is representative of property conditions and changes to conditions to a pool 1810 and hot tub 1820 area wherein non-effected exterior rails (stippled areas 1830) may be differentiated from effected (bent or broken) exterior rails (identified by cross-hatched areas 1840) which may be equally signified for the consumer of information via a color scheme or similar designation.

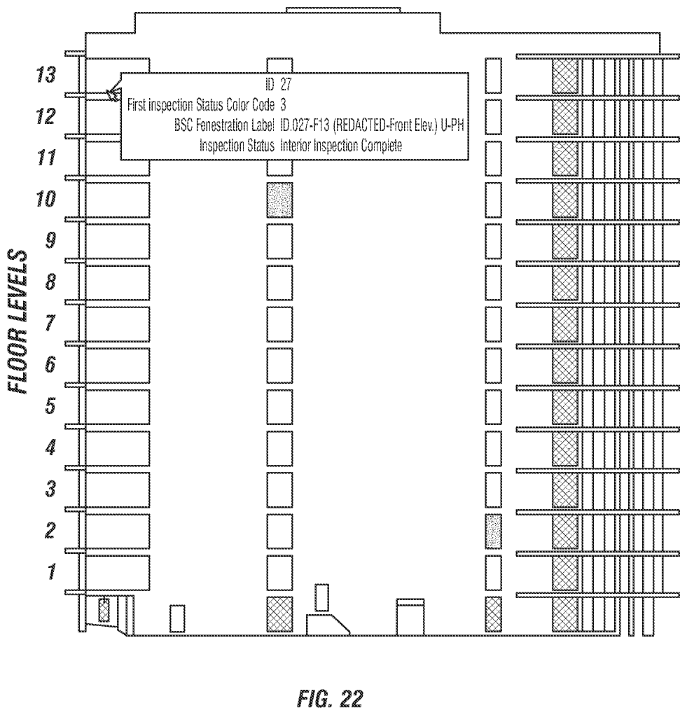

What is more, as in FIG. 22, the present SAM system allows for “mouseover” (“roll over”) and “point-and-click” access to individual units, subunits and areas. The mouseover is defined by a graphic control element that is “activated” or accessible when the user moves or hovers above a particular unit, subunit or area and selects its content. These subdivided areas may also provide a preview of the accessible area wherein the special usage of a mouseover creates a related “preview” or “tooltip” (a.k.a. an “infotip” or “hint”) which is a GUI element allowing for information to be displayed wherein simply moving the pointer tip to the designated area, without clicking or selecting the area, provides a text box or image box (e.g., a balloon) describing an abbreviated information set (e.g., unit or ID number, conditions type, conditions location, inspection time and/or truncated annotated conditions notes and the like). In FIG. 22, the identified unit on the 13^{th} floor is designated ‘ID 27’ and has the label of ‘Interior inspection Complete’ signifying to the consumer that the inspector or inspectors have completed their inspection and that the report is accessible. Further, this abbreviated text or image box may be displayed so long as a cursor or pointer “hovers” over the component or element, without selecting, said component or element. What is more the text box or image may contain one to a plurality of “nested” tooltips or tooltips which overlap into multiple layered tooltips.

The tooltips themselves may contain links, hyperlinks or similar gateways to more detailed information including reports, analyses, visual representations or conclusory statements involving the identified unit. Here, information is accessible via “hoovering” over a component or element, but the information may be displayed within a “bubble” (as depicted) or at an area away from or remotely from said tooltip (e.g., a toolbar). Similarly, adjustments may be made to accommodate mobile operating systems (e.g., “long-pressing” or tapping and holding) in order to convey information on a table or mobile device.

What is more, the user/consumer may choose to expand or retract the visualization as to access the presented representation in finer or coarser detail.

Once the user finalizes the hovering stage and actually selects the component or element, the user may then be directed to a subfolder or hyperlinked to an information depository containing the full inspection report (videographic evidence, transcribed verbal descriptions and annotated descriptions) of a particular area, unit, or subunit. Once accessed, the user may then have access to a full report or may be further directed to more embedded or layered information specific to a particular unit, subunit or area.

Upon accessing and analyzing said information above, the user may then “close” a particular unit, subunit or area and once again return to the primary GUI which may then allow the user to select another unit, subunit or area or to a structure or property in its entirety. At this primary GUI, selected units, subunits or areas may be identifiable by color, shading or another signifying indications (e.g., arrows, shading) as to indicate either access or conditions type (fenestration state, water existence, rail conditions, or no change in conditions). Furthermore, said primary GUI may exist as a single interface or may exhibits various tabs or filters (i.e., alternative overlays or screens) depicted specific types of conditions or changes in conditions (e.g., fenestration changes, guardrail conditions, moisture presence and extent and the like) and/or accessibility of a unit where access may be denied or unattainable for a single unit resident within a structure.

### Preferred Embodiments

It is a preferred embodiment of the present invention to provide a holistic assessment of conditions occurring both exteriorly and interiorly to buildings and property to establish an acceptable explanation as to causal events, or lack thereof, giving rise to conditions incurred in and to a structure, area or location especially in relation to a significant weather event.

It is another preferred embodiment to provide a system for examining structures and related areas for changes or no changes in property conditions, through (1) externally and internally captured images, (2) external and internal manual inspection(s), (3) instrument measurement, (4) publicly and/or privately available property descriptions, and (5) publicly and/or privately available data images, in conjunction with (6) meteorological data, to provide a forensic analysis of conditions causes and derivation. Said analysis procurement includes imaging from imaging devices, analytical instrumentation measurements, inspection reports and a historical repository of collected related categories of property conditions incident types compared and compiled into a single opinion assessing property conditions extent, conditions derivation and primary and secondary causes.

In yet another preferred embodiment, a repository exists which encompasses, for each property condition event type recorded, a catalog of event-related, manufacture-related, wear-related and age-related factors attributable to all manner of property conditions-effecting events with which to compare newly collected and derived conditions information to procure and provide an accurate assessment of a property conditions or change in conformational condition's cause or causes wherein the present system accurately collects, preserves, documents, analyzes, and presents data associated with properties, buildings, or valuable assets in a novel, accessible and centralized database.

In yet another preferred embodiment nature (weather) or natural (wear and age) occurrence may be differentiated from non-natural or man-made occurrences in determining causality in a structure, area or location.

In another preferred embodiment a detailed analysis may be taken of a newly completed structure (and surrounding areas) as to provide a basis for future analysis and/or monitoring of a structure or property which may thereby be used comparatively to (1) determine initial structural integrity, (2) monitor structural soundness over time, (3) screen structures for wear over time, (4) monitor existing structures exhibiting similar design and/or materials, and (5) serve for a basis of conditions analysis, retrospectively, where a baseline is established.

In yet another embodiment the above analysis may be completed on a newly completed structure, individually, as a basis for assessing future conditions or future wear. Alternatively, the present system may be used collectively, based on design and materials, to not only identify and track individual structures, but also to follow structures in aggregate to better determine future causation, as a means to follow structural wear on a plurality of structures or prospectively to predict and preclude future failures.

It is another embodiment to utilize the same SAM system to assess conditions on single-family dwellings, multi-family dwellings, non-residential buildings and commercial properties in terms of conditions of fenestrations, roof conditions, exterior conditions, water and moisture conditions, conditions to specific elements as well as conditions to contiguous areas and property. Expressly, imaging in a residential assessment may be accomplished in a fraction of the time of a multi-level structure with equal accuracy.

It is yet another embodiment to allow for real-time access to conditions data (e.g., fenestration conditions, frame conditions, HVAC conditions, roof conditions, structural conditions and the like), both written and photographic, during mediations, trails and hearings where claims may be fully validated, removing ambiguity from traditional proceedings using percentage-of-risk limited investigations and extrapolations.

It is another embodiment to use the present SAM system on complex properties with multi-roof fields and types (e.g., asphalt-composition shingles, low-sloped roofing, metal panels, concrete, clay, TPO membrane, polymer panel and/or cement-based material with sealant) which can include conditions secondary to essential roofing elements (e.g., gutters, awnings, downspouts and the like.

In one other embodiment, the present SAM system and method of use, in addition to fenestration evaluation and inspection and water/moisture conditions, whether through fractures glazing or wind-induced infiltration, the present system may be further used to inspect and assess other external elements including guardrails, floor tiles/floor coatings, externally-residing light fixtures, outlets, fire safety equipment, vents and outside common areas (i.e., pools, hot tubs and grill up to and including railings around these areas).

It is another preferred embodiment to use the present SAM invention to assess HVAC condenser conditions including refrigerant type tracking, impact/deformation conditions, repairability/compatibility and code-requirement tracking primary on rooftops and the like.

It is yet another preferred embodiment to use the present system for a unit-by-unit validation of repairs wherein documentation of system conditions may be conducted to confirm and authenticate that necessary repair were in fact undertaken post-settlement.

Therefore, is the stated goal of the present invention to accurately collect, preserve, document, analyze, and present data associated with properties, buildings, or valuable assets in a novel accessible and centralized database that allows for principals to utilize a graphically interactive model to dynamically select and retrieve desired information based on visual electronic cues that graphically depict physical conditions on the property, structures, or valuable assets. Through the resultant spatial analysis model (SAM), interested parties accessing data may more quickly, efficiently and accurately retrieve information, interpret the data, and/or make decisions based on the data in real time through the SAM process which exhibits a vast improvement over traditional methods which result, historically, in costly delays in acquiring and interpreting data.

I claim:

1. A spatial analysis method for determining loss via inspecting structures, property and related areas for conditions and condition changes comprising:
gathering meteorological data related to a specific weather event or historic events;
gathering time data related to a specific weather event;
gathering public images, private images or a combination thereof;
said images being photographic images, videographic images or a combination thereof;
gathering public written descriptions, private written descriptions, or a combination thereof, related to a particular structure, related property or both;
conducting a visual, on-site conditions inspection of a condition or conditions of elements of a structure, a property, or a combination thereof;
said inspection consisting of captured photographic images, videographic images or a combination thereof;
said inspection further consisting of verbal descriptions of condition's location, extent, degree or the absence of condition;
said inspection further consisting of written descriptions of condition's location, extent, degree, or the absence of conditions;
collecting inspection data comprising images and descriptions;
recording said inspection data;
combining said event-specific meteorological data, event-specific weather time data, public and private images and descriptions of said structures and related property, and visual, on-site inspection data into a central depository;
processing said specific weather event meteorological data, specific weather event time data, public and private images and descriptions of said structures and related property, and visual, on-site inspection data into a single forensic analysis conditions report;
displaying said forensic analysis conditions report visually and in written form via an interactive, accessible display;
establishing causative relation between structural and property conditions to said specific weather event.

2. The method of claim 1, wherein said specific weather event may be any present or past weather event exhibiting high-wind velocities, rain, hail, debris or a combination thereof.

3. The method of claim 2 wherein inspection data may include observational data, verbal data, written data, analytical data, instrumentation measurements of a structure, property or area.

4. The method of claim 3 wherein condition or conditions conformational changes or no change comprises:
condition
structural conditions;
interior structural conditions;
exterior structural conditions;
foundation conditions;
HVAC conditions;
fenestrations: fractured glazing, loose glazing, fogged glazing, scratched/etched glazing or a combination thereof;
fenestration assemblies: bent fenestration frames, bowed fenestration frames, dislodged fenestration frames, dented fenestration frames, or a combination thereof;
infiltrated water existence or non-existence within a structure;
extent of water existence, if present;
manufacture-related defects;
installation defects;
wear-related defects;
age-related defects; and
historical conditions or repair and disrepair.

5. The method of claim 4 wherein the location, degree, extent, or a combination thereof, may be observed, measured, collected, recorded, categorized, processed, and stored in a centralized database and presented for consumer access, analysis and review.

6. The method of claim 4 wherein said water existence may be infiltrated water in the form of a liquid, a gas or combination thereof.

7. The method of claim 6 wherein water may be associated with a fractured glazing or an intact glazing signifying a storm created opening or a wind driven rain event, respectively.

8. The method of claim 1 wherein said visual, on-site conditions inspection of a condition or conditions, or change in conditions, of elements of a structure, a property, or a combination thereof, is conducted by a technician or plurality of technicians utilizing a site-specific set of queries explicit to a particular inspection site.

9. The method of claim 7 wherein collected weather, time and condition or conditions data is displayed to an information consumer in both visual and written forms in an informational interactive format.

10. The method of claim 9 wherein said information may be presented spatially within a representation of the structure, property, or combination thereof, whereby the information consumer may be informed as to condition or conditions, incidences, degrees, extents, locations, or absence thereof, diagrammatically and interactively.

11. The method of claim 10, wherein said structure or property representation may have more detailed information embedded within areas of its construct accessible via mouseover and tooltip.

12. A system of determining loss via inspecting structures, property and related areas for conditions and condition changes comprising a:
meteorological data including wind direction and wind velocity;
structure orientation;
said structure's windward and leeward side or sides;
time data;
public and private images and descriptions of said structures, property and related areas;
on-site, in person collected inspection data;
said inspection data comprising photographic images of conditions and condition changes, videographic imaging of changes or condition changes, verbal descriptions of changes or condition changes, written descriptions of changes or condition changes;
a computing device;
said computing device having a CPU;
said computing device having a memory;
said computing device having instructible and programmable software platform for categorization and display of collected meteorological data, time information, public and private images and descriptions and inspection data;
said computing device having wired, wireless, or a combination thereof, means of communications, network connectivity and cloud storage;
a consolidated repository stored in the memory containing meteorological data, time data, public and private images and descriptions and inspection data for collection, recording, storing, categorization, analysis, presentation and display;
said repository accessible by a technician to transmit inspection data, an administrator for collection and editing of inspection data and a consumer for utilizing the consolidated information.

13. The system of claim 12 wherein said condition, conditions or change in condition or conditions comprise the following structural elements:
fenestrations, glazing, fenestration frames, doors, windows, balcony railings, guard railing, balcony tile, flooring, light fixtures, outlet covers, vent covers, exit signs, fire safety equipment; and
consequential elements: moisture and water filtration.

14. The system of claim 13 wherein condition or condition changes may be due to a specific weather-related event, a past weather related event, age, wear, improper installation, manufacturer/manufacturing defects, latent defects, due to a non-weather-related event or absent.

15. The system of claim 12 wherein said collected data may be presented in a visual display, a written format, or both, for condition or conditions review and analysis as to determine condition or conditions presence, absence, location, degree, occurrence rates, extent and causation.

16. The system of claim 15 wherein causation may be determined by taking into consideration meteorological data including wind direction and velocity, the orientation of an inspected structure or property, the windward and leeward sides of a structure, conditions present, absence of conditions, distribution of conditions, location of conditions, extent and degree of conditions, groupings of conditions and relativity to the presence of absence of all other conditions.
